(19) United States
(12) Patent Application Publication
(10) Pub. No.: US 2008/0302432 A1
(43) Pub. Date: Dec. 11, 2008

(54) Apparatus & method for propelling a liquid in a spiral spray

(75) Inventor: David J. Fitzgerald, Hayward, CA (US)

Correspondence Address: Law Offices of John W. Carpenter, 405 Davis Court, Suite 707, San Francisco, CA, 04111, US

(73) Assignee: WHAM-O, Inc., Emeryville, CA (US)

(21) Appl. No.: 11/810,579

(22) Filed: Jun. 6, 2007

(51) Int. Cl. F15C 1/16

(52) U.S. Cl. 137/808

(57) ABSTRACT

An embodiment of the present invention provides an apparatus for propelling a fluid in a spiral stream. The apparatus includes a housing, and a cap member connected to the housing and discharges a stream of fluid in a spiral stream. A large gear member is coupled to the cap member for causing the cap member to rotate when the large gear member rotates. A gear assembly transfers rotation of an impeller to the large gear member when the impeller is contacted by fluid passing through an impeller opening in am impeller support. An embodiment of the present invention also provides a method for propelling a fluid in a spiral stream.

### FIELD OF THE INVENTION

Embodiments of the present invention are related to an apparatus that discharges or propels a liquid. More specifically, embodiments of the present invention provide an apparatus and method for propelling water in a spiral spray or stream.

### BACKGROUND OF THE INVENTION

There are a number of water-dispersion devices available for children's recreational purposes, such as water slides, water-spraying devices, sprinkler hoops, etc. However, none combine the features of an apparatus for propelling water in a spiral fashion or motion onto a slick, smooth, non-porous mat which enables a person to slide along the surface of the mat.

### SUMMARY OF EMBODIMENTS OF THE INVENTION

Embodiments of the present invention provide an apparatus for propelling a fluid in a spiral stream. The apparatus includes a housing and a cap member coupled to the housing. The cap member has an opening where through a fluid passes in a spiral stream when the cap member rotates. A large gear member is coupled to the cap member for causing the cap member to rotate when the large gear member rotates. The apparatus also comprises an impeller support having an opening where through the fluid may pass. A generally U-shaped block is supported by the impeller support and over the opening. An impeller is rotatably supported by the support block for rotating when fluid passes through the opening. A gear assembly is engaged to the large gear member and is coupled to the impeller for transferring impeller rotation to the large gear member to cause the cap member to rotate, as well as the housing.

Embodiments of the present invention also provide a method for propelling a fluid in a spiral stream. The method comprises passing a fluid through a pair of tubes slidably engaged to each other. The impeller is caused to rotate by passing the fluid through an opening in a support member and subsequently contacting the impeller. The method further includes transferring the rotation of the impeller to a rotating cap member from which the fluid is propelled as a spiral stream.

These provisions, together with the various ancillary provisions and features which will become apparent to those skilled in the art as the following description proceeds, are attained by the methods and assemblies of the present invention.

### BRIEF DESCRIPTION OF THE DRAWINGS

FIG. 1 is a segmented perspective view of an embodiment of the invention.

FIG. 2 is another segmented perspective view of an embodiment of the invention.

FIG. 3 is a segmented top plan view of the small-gear assembly, the shaft that passes through and binds to the bore of the small-gear assembly such that the shaft and the small-gear assembly rotate together, and the large gear that engages the small-gear assembly for being rotated by the small-gear assembly.

FIG. 4 is a vertical sectional view of an embodiment of the invention illustrating the cap member coupled to the large gear which is captured by the housing and the cap member and is turned or rotated by the small-gear assembly.

FIG. 5 is a side elevational view of the large gear spaced from the cap member with the arrows indicating the direction of movement of the large gear towards the cap member for coupling the large gear to the cap member.

FIG. 6 is a side elevational view of another embodiment of the invention illustrating a generally circular support member supporting a generally U-shaped hollow support block, a cylinder for receiving an end of a shaft that passes through and is bound to a bore of the small-large gear assembly, and an upright support member having a recess for rotatably holding a shaft that supports and is bound to a worm gear which engages and rotates the small-large gear assembly.

FIG. 7 is a side elevational view of the embodiment of the invention having the small-large gear assembly bound to a shaft whose end is rotatably seated in a recess in the cylinder, and the worm gear engaged to the small-large gear assembly and bound to the shaft that rotatably seats in the recess of the upright support member.

FIG. 8 is a top plan view of the small-large gear assembly engaged to the worm gear.

FIG. 9 is a perspective view of the apparatus for propelling water in a spiral spray onto a slip & slide mat.

FIG. 10 is a side elevational view of a hose conduit connected to and extending from a hose connector, and a conduit spaced from the hose conduit and depending from an impeller support of the apparatus with the arrows indicating the direction of movement of the hose conduit towards the conduit for slidably coupling the hose conduit to the conduit.

FIG. 11 is top plan view in direction of the arrows along the plane of line 11-11 in FIG. 1.

FIG. 12 is a sectional view of the U-shaped support block illustrating the opening the impeller support to allow fluid to pass through the opening and contact the impeller represented by dashed lines.

FIG. 13 is a perspective view of the U-shaped support block having the clamp disposed thereon for holding the impeller shaft in a pair of opposed recesses in the walls of the U-shaped support block.

FIG. 14 is a partial vertical section view of the support for the impeller assembly and disposed within the housing with the conduit extending downwardly having the U-shaped support block disposed thereon

### DETAILED DESCRIPTION OF THE EMBODIMENTS OF THE INVENTION

In the description herein, numerous specific details are provided, such as examples of components and/or methods, to provide a thorough understanding of the embodiments of the present invention. One skilled in the relevant art will recognize, however, that an embodiment of the invention may be practiced without one or more of the specific details, or with other apparatus, systems, assemblies, methods, components, materials, parts, and/or the like. In other instances, well-known structures, materials, or operations are not specifically shown or described in detail to avoid obscuring aspects of the embodiments of the present invention.

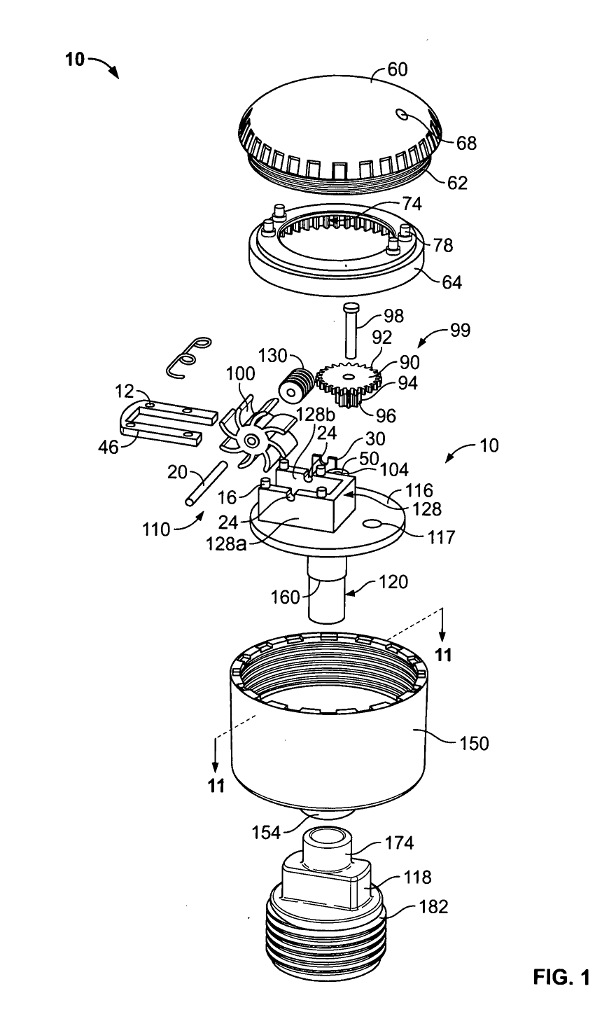

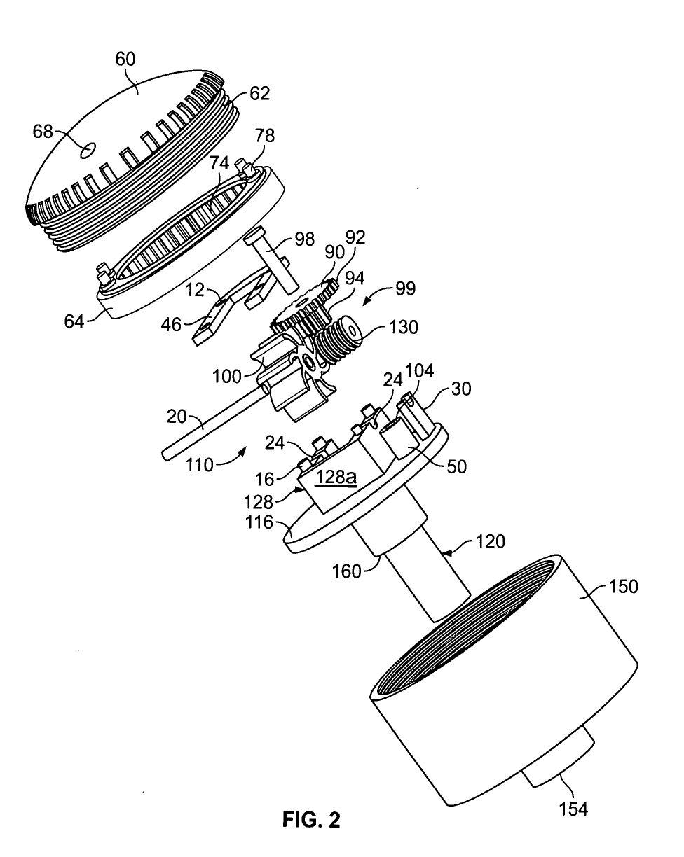

Referring in detail now to the drawings, wherein similar parts of the invention are identified by like reference numerals, there are seen in FIGS. 1 and 2 segmented perspective views of an apparatus, generally illustrated as 10, for propelling a fluid (e.g., a liquid such as water) in a spiral stream 14 as best shown in FIG. 9. As further best shown in FIG. 9, the apparatus 10 is supported by a generally arcuate-shaped inflatable member 18 that transverses in a spaced relationship a slip & slide mat 22. The spirally discharged liquid stream 14 falls on the slip & slide mat 22 for providing a wet surface upon which a person may longitudenly slide.

The apparatus 10 includes a cap 60 having a threaded section 62 and an opening 68 through which the fluid is discharged in a spiral stream 14 as the cap 60 rotates in accordance with the procedure set forth hereafter. The cap 60 has an oval (downwardly tapering) surface in which the opening is off set from the center of the cap 60. A gear 64 is a ring-like member which is coupled to cap 60 for rotating simultaneously or in unison with the cap 60. The internal perimeter of the gear 64 has a geared surface 74 with a plurality of teeth. Coupling of the gear 64 to the cap 60 may be by any suitable means, such as by screwing a suitable surface of gear 64 with a suitable surface of cap 60. In an embodiment of the invention, gear 64 has upstanding pegs 78 which pass into recesses 82 of the cap 60 for coupling and/or engaging cap 60 to or with the gear 64, as best shown in FIG. 4, and in FIG. 5 which is a side elevational view of the gear 64 spaced from the cap 60 with the arrows indicating the direction of movement of the gear 64 towards the cap 60 for inserting the pegs 78 into the recesses 82 for coupling and/or engaging the gear 64 to the cap 60.

The apparatus 10 also includes a gear assembly, generally illustrated as 99 and engaged to the gear 64 and coupled to an impeller (identified as “100” below) for transferring rotation of the impeller to gear 64 to cause the cap 60 to rotate along with gear 64, and to further cause a housing (identified as “150” below) to rotate in response to cap 60 rotating. The coupled combination of cap 60, gear 64 and the housing rotate together and in unison.

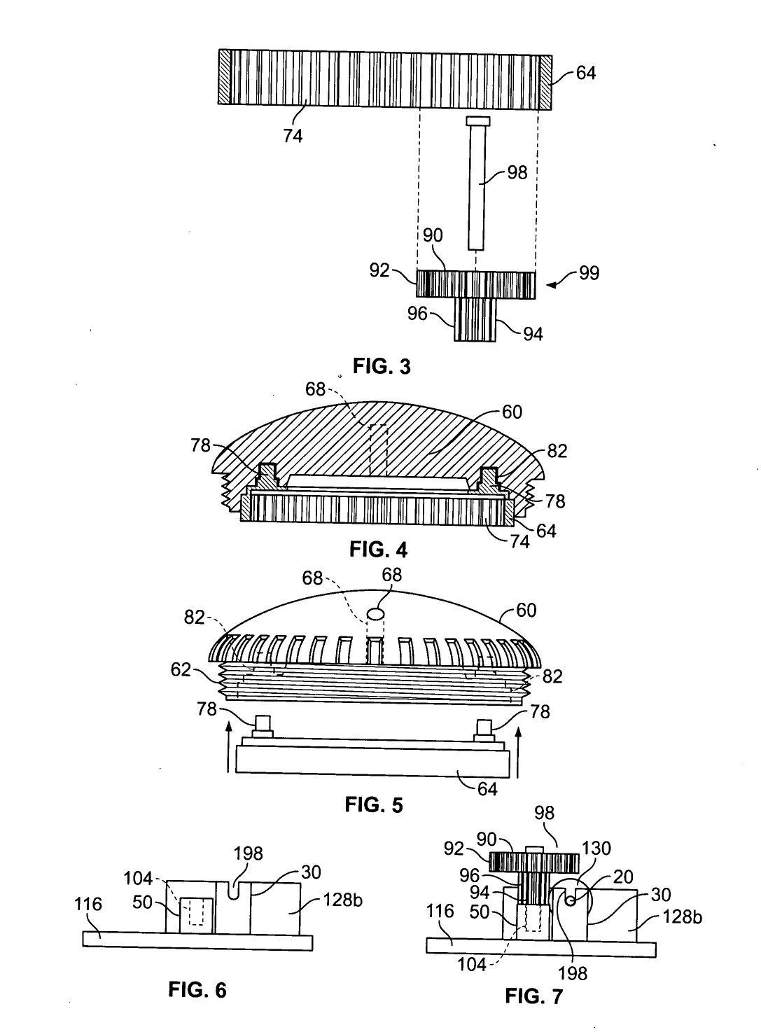

The gear assembly 99 comprises gear 90 bound to gear 94 for rotating therewith (see FIGS. 3, 7 and 8). Shaft 98 passes through a bore which extends through gears 90 and 94. An end of the shaft 98 seats in recess 104 of a cylinder 50 for maintaining the gears 90 and 94 in a position for rotating around or with the shaft 98. Gear 90 has a geared surface 92 having a plurality of teeth for engaging or meshing with the teeth of geared surface 74 of gear 64. As gear 94 is caused to rotate around or with shaft 98 by a rotating worm gear (identified as “130” below) engaging gear 94, gear 90 rotates. As gear 90 rotates, the teeth of the geared surface 92 of gear 90 meshed with the teeth of geared surface 74 of gear 64 causes the latter to rotate. As gear 64 rotates, cap 60 rotates. Gear 64 is caused to rotate from its associated teeth meshing with the teeth of the geared surface 92 associated with the rotating gear 90.

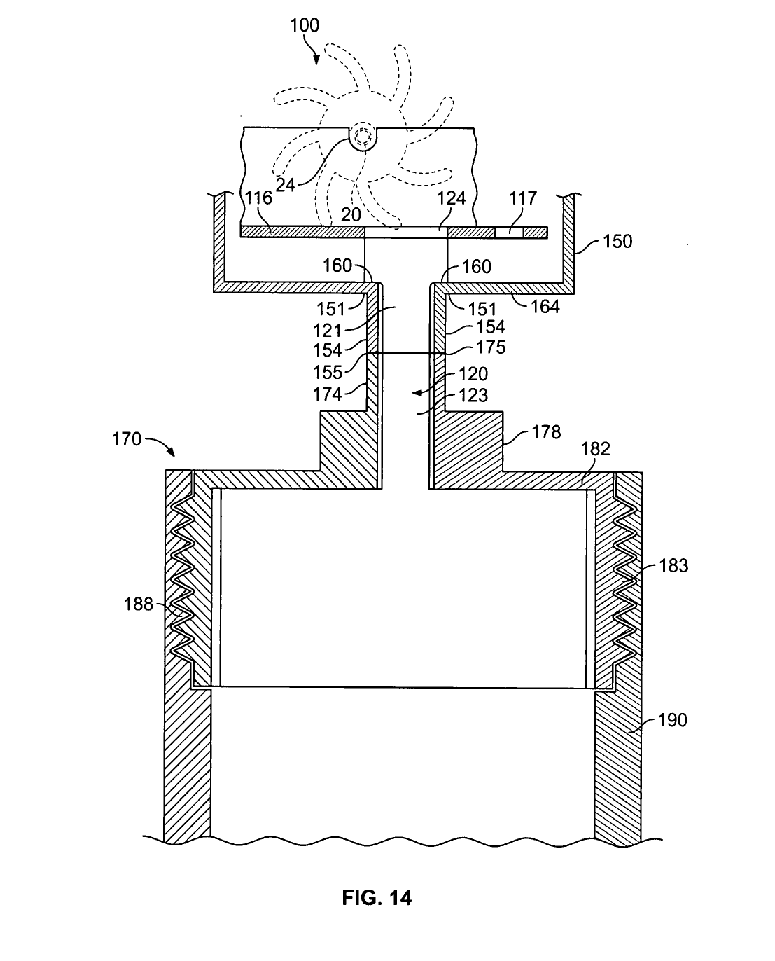

The apparatus 10 further includes an impeller assembly, generally illustrated as 110. Impeller assembly 110 comprises a support 116 which is disposed in a housing 150 as best shown in FIG. 14. The housing 150 has a bottom 164. Support 116 has an opening 117 which forms a vent. Connected to the support 116 in a depending relationship is a conduit 120 which communicates with an opening 124 in the support 116 and through which fluid flows for contacting and rotating/driving an impeller 100. Conduit 120 has an upper section 121 and a lower section 123. As best shown in FIG. 14, a section of conduit 120 is flanged to provide a shoulder 168. Since the conduit 120 remains steadfast, when housing 150 rotates, a section 151 of the bottom 164 of the housing 150 rotates against the underside of the shoulder 168.

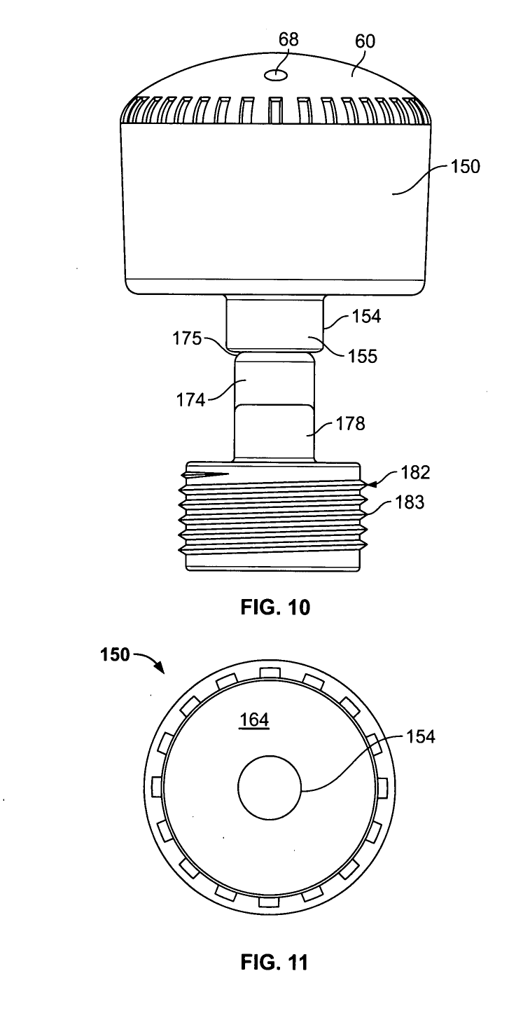

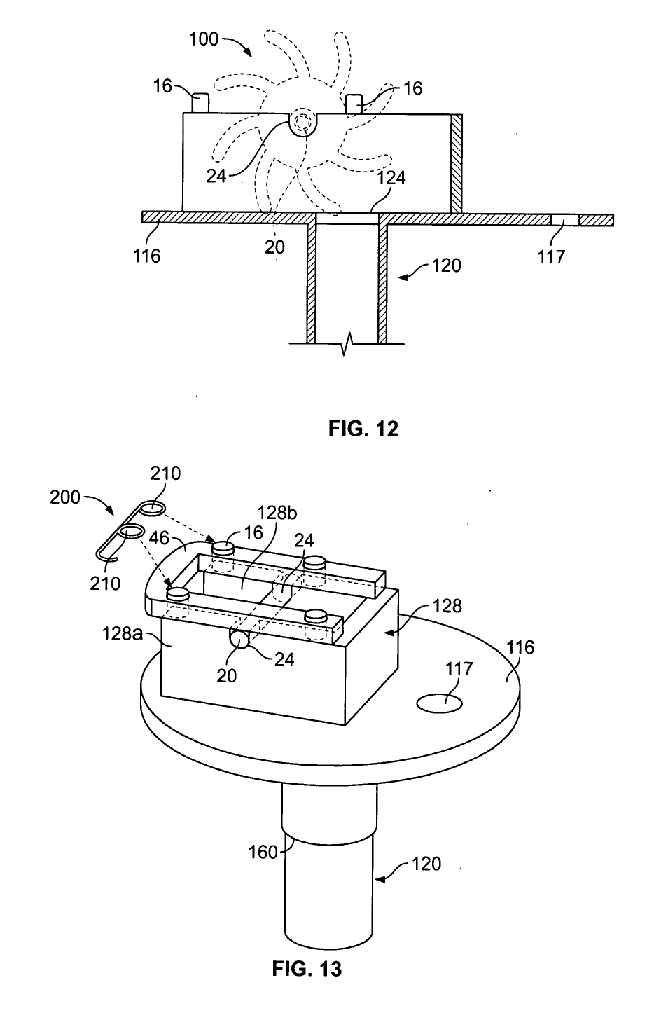

Coupled to and extending downwardly from the housing 150 is collar 154 (see FIGS. 10 and 14) which terminates in end 155. As housing 150 rotates, collar 154 of the housing 150 rotates around the upper section 121 of the conduit 120. The direction (i.e., clockwise or counter clockwise) of the housing 150 depends on the direction of rotation of the cap member 60, which in turn, depends on the direction of rotation that is transferred to the gear assembly 99 from the impeller (identified as “100” below). The direction of rotation of the impeller is dependent on the disposition of its associated blades. Liquid contacting impeller blades curved or disposed in one direction causes an impeller rotation that is opposite to the impeller rotation caused by liquid contacting impeller blades curved or disposed in the opposite direction.

The apparatus 10 further includes a connector assembly, generally illustrated as 170 and best shown in FIG. 14. The connector assembly 170 has a conduit 174 supported by a shoulder conduit 178. Conduit 174 terminates in end 175. Integrally bound to the shoulder conduit 178 is a hollow connector body 182 which has a threaded section 183 for meshing a threaded section 188 of a connector hose 190 (see FIG. 14). The lower section 123 of conduit 120 is bound to the inside cylindrical surface of conduit 174 and/or shoulder conduit 178, such that the connector assembly 170 remains stationary, along with conduit 120, as the housing 150 rotates. When housing 150 rotates, the end 155 of collar 154 (depending from the bottom 164 of housing 150) rotates against the stationary end 175 of the conduit 174 upstanding from the shoulder conduit 178. As liquid enters the general hollow body 182 of the connector assembly 170 from the hose 190, the liquid passes into the lower section 123 of conduit 120. As indicated, the lower section 123 of conduit 120 is connected or coupled to the internal cylindrical surface of conduit 174 and/or shoulder conduit 178 such that as section 151 of the bottom 164 of housing 150 rotates against the underside of the shoulder 168, conduit 120 will remain stationary and not rotate since the connector assembly 170 (along with its associated conduits 174 and 178) does not rotate.

Impeller assembly 110 further comprises a generally U-shaped support member 128 which is disposed over and around the opening 124. The U-shaped support member 128 has a pair of arms 128a and 128b. Any liquid discharged from the conduit 120 passes through the opening 124 and into the U-shaped support member 128 between its associated arms 128a and 128b. Each of the arms 128a and 128b has a recess 24 for providing a seat for shaft 20 to rotate therein. In addition to having recesses 24, each of the arms 128a and 128b supports pegs 16.

A clamp member 46 is shown as having apertures 12. The clamp member 46 is disposed over the arms 128a and 128b such that pegs 16 pass into the apertures 12 (as best shown in FIG. 13) in order that shaft 20 does not leave recesses 24-24, particularly during rotation. As also best shown in FIG. 13, a retainer member 200 is illustrated as having eyelets 210-210 which slip over and around two of the pegs 16-16 for locking and maintaining the clamp 46 in its position over the arms 128a and 128b.

Each arm 128a and 128b has a recess 24 (see FIG. 13) for providing a seat for shaft 20 to rotate therein. The shaft 20 passes through and is bound to an impeller member 100 which is disposed between the pair of arms 128a and 128b for rotating with the shaft 20 when contacted by any liquid discharged from the conduit 120. The force of the discharging liquid hits the blades of the impeller member 100, causing the impeller member 100 to rotate along with the shaft 20 bound thereto.

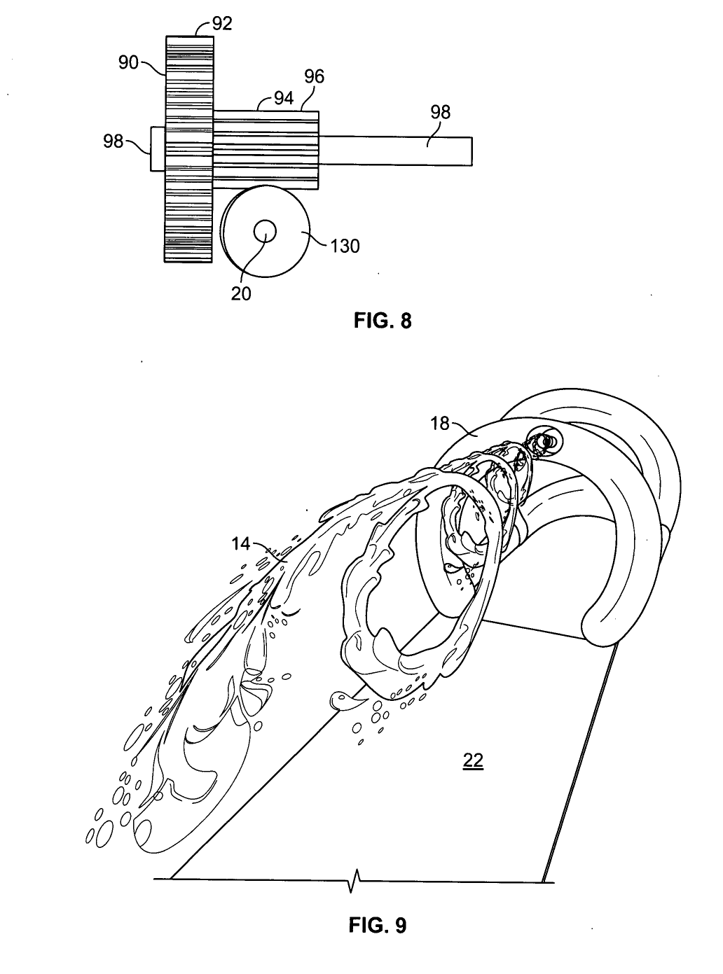

The shaft 20 extends beyond arm 128b of the U-shaped support member 128 and has an end which rotatably seats in a recess 198 in an end of the upright support member 30. The shaft 20 extends through a worm gear 130 which is located between the upright support member 30 and arm 128b of the U-shaped support member 128, as illustrated in FIG. 8. The worm gear 130 engages gear 94 and is bound to the shaft 20 such as to rotate therewith. As the worm gear 130 is rotated by the shaft 20, the engaged gear 94 rotates which causes gear 90 to rotate. The rotational movement of gear 90 is transferred to gear 64. As gear 64 rotates the cap 60 coupled thereto rotates therewith. Any liquid passing through gear 64, passes into the cap 60 (i.e., into and against the underside of the cap 60). Opening 60 provides a bore for liquid to pass through the cap 60. As liquid passes and exits through opening 60, it is propelled in a spiral stream or fashion due to the rotating cap 60.

Continuing to refer to the drawings for operation of the invention, liquid (i.e. water) passes out of hose 190 and into the hollow body 82 of the connector assembly 170. From the hollow body 82 the liquid passes into the lower section 123 of conduit 120 and then into the upper section 121. As previously indicated, the lower section 123 of conduit 120 is bound to the internal cylindrical surface of conduit 174 and/or shoulder conduit 178 such that as section 151 of the bottom 164 of housing 150 rotates against the underside of the shoulder 168, conduit 120 will remain stationary and not rotate since the connector assembly 170 (along with its associated conduits 174 and 178) does not rotate. When housing 150 rotates, the end 155 of collar 154 (depending from the bottom 164 of housing 150) rotates against the stationary end 175 of the conduit 174 upstanding from the shoulder conduit 178.

As further indicated, any liquid discharged from the conduit 120 passes through the opening 124 and into the U-shaped support member 128 between its associated arms 128a and 128b. As the liquid contacts the impeller 100, which is connected to shaft 20 that is transversely situated across the 128a and 128b, impeller 100 rotates. The rotational movement of the impeller 100 bound to shaft 20 causes the worm gear 130 to rotate. As previously mentioned, worm gear 130 is bound to shaft 20 such that when shaft 20 is caused to be rotated by the impeller 100, worm gear 130 rotates and imparts rotation to gear 94. Rotation of gear 94 rotates gear 90 which is bound to gear 94.

Gears 90 and 94 may be either bound to or unbound to shaft 98. If gears 90 and 94 are bound to shaft 98, as gears 90 and 94 rotate, shaft 98 rotates while its end is rotatably seated in recess 104 of a cylinder 50. If gears 90 and 94 are not bound to shaft 98, gears 90 and 94 rotate around shaft 98 while its end is steadfastly seated or affixed within recess 104 of a cylinder 50. When gear 90 rotates, gear 64 rotates, causing the cap 60 which further causes the housing 150 to rotate. The coupled combination of cap 60, gear 64 and housing 150 rotate together and in unison.

After liquid finishes contacting and rotating impeller 100, the liquid passes through the internal opening of the ring-like gear 64, and subsequently through the opening of the cap 60 to leave the cap 60 as a propelled spiral stream or spay of liquid which in an embodiment of the invention, lands on the slip and slide mat 22 to provide a wet surface for a person to slide longitudinally thereon.

Reference throughout this specification to “one embodiment”, “an embodiment”, or “a specific embodiment” means that a particular feature, structure, or characteristic described in connection with the embodiment is included in at least one embodiment of the present invention and not necessarily in all its embodiments. Therefore, the respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Additionally, any arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of the illustrated embodiments of the present invention and are to be included within the spirit and scope of the present invention.

Therefore, while the present invention has been described herein with reference to the particular embodiments thereof, a latitude of modification, various changes and substitutions are intended in the foregoing disclosures, and it will be appreciated that in some instances some features of the embodiments of the invention will be employed without the corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. An apparatus for propelling a fluid in a spiral stream comprising:
a housing;
a cap member coupled to the housing and having a cap structure defining an opening where through a fluid is propelled as a spiral stream;
a large gear member coupled to the cap member for causing the cap member to rotate when the large gear rotates;
an impeller-support assembly having an impeller support having a structure defining an impeller opening where through fluid passes, a generally U-shaped, support block supported by the impeller support and over the impeller opening, and an impeller rotatably supported by the support block for being contacted by fluid passing through the impeller opening for causing the impeller to rotate; and
a gear assembly engaged to the large gear member and coupled to the impeller for transferring impeller rotation to the large gear member to cause the cap member to rotate the large gear member and to cause the housing to rotate in response to the cap member rotating.

2. The apparatus of claim 1 wherein said impeller support includes an aperture.

3. The apparatus of claim 1 wherein said support block includes at least one groove.

4. The apparatus of claim 1 additionally comprising a shaft bound to the impeller and rotatably sitting in said groove.

5. The apparatus of claim 1 additionally comprising a support member engaged to said impeller support.

6. The apparatus of claim 1 wherein said support member includes a recess wherein said shaft rotates.

7. The apparatus of claim 4 additionally comprising a worm gear secured to said shaft.

8. The apparatus of the claim 7 additionally comprising a cylinder member secured to said impeller support, a gear shaft having an end that seats within said cylinder member.

9. The apparatus of claim 8 additionally comprising a small gear member engaged with said worm gear, a large gear member connected to the small gear member, and a cap gear member engaged to the large gear member and to said cap member.

10. The apparatus of claim 1 additionally including a connector assembly engaged to the housing.

11. An assembly for receiving a fluid comprising a housing, and a connector assembly against which he housing rotates.

12. A method for propelling a fluid in a spiral stream comprising:
passing a fluid through a pair of tubes in communication with each other;
rotating an impeller by passing the fluid through an opening in a support member and contacting the impeller which is rotatably supported by a generally U-shaped impeller support member; and
transferring the rotation of the impeller to a rotating cap member having an opening through which the fluid is propelled as a spiral stream.

13. The method of claim 12 additionally comprising rotating a housing member around a tube that is coupled to a connector assembly.

14. The method of claim 13 wherein said housing member includes a collar, and said method additionally comprising rotating the collar around the upper section of the tube.
